(19) United States
(12) Patent Application Publication
(10) Pub. No.: US 2002/0067856 A1
(43) Pub. Date: Jun. 6, 2002

(54) Image recognition apparatus, image recognition method, and recording medium

(76) Inventors: Iwao Fujii, Toyokawa-shi (JP); Hiroyuki Ideyama, Toyokawa-shi (JP); Tsutomu Fujino, Sanda-shi (JP); Manji Takano, Amagasaki-shi (JP); Yoshihiro Hara, Kishiwada-shi (JP); Daisetsu Tohyama, Amagasaki-shi (JP)

Correspondence Address: SIDLEY AUSTIN BROWN & WOOD LLP, 717 NORTH HARWOOD, SUITE 3400, DALLAS, TX, 75201, US

(21) Appl. No.: 09/998,985

(22) Filed: Nov. 30, 2001

(30) Foreign Application Priority Data
Dec. 1, 2000 (JP) 2000-367830

(51) Int. Cl. G06K 9/68

(52) U.S. Cl. 382/218

(57) ABSTRACT

An image recognition apparatus, an image recognition method and a recording medium are provided, each capable of decreasing the reduction in the success rate in recognition, particularly, when a subject of a photographic image is recognized. An image input from a PC, or the like, can be recognized by use of the reference images stored in a reference image memory, and a date of photo taking of the reference image that is determined to be similar to the input image can be compared with the date of photo taking of the input image. When the input image is newer, the reference image can be renewed based on the input image.

This application is based on application No. 2000-367830 filed in Japan, the content of which is hereby incorporated by reference.

### BACKGROUND OF THE INVENTION

1. Field of the Invention

The present invention relates to an image recognition apparatus that recognizes images, and more particularly, to a technology to prevent reduction in the success rate in recognition when a subject of a photographic image is recognized.

2. Description of the Related Art

In recent years, as digital cameras have become widespread, various kinds of image recognition apparatuses that recognize subjects of image data taken by the digital cameras have been devised. For example, a technology is known wherein characteristics and descriptions of various kinds of subjects are previously stored and when a characteristic of a subject taken by a digital camera coincides with a stored characteristic, the image data generated by the photo taking and the description of the subject are displayed being superimposed one on another. Moreover, a technology is known wherein image information of the faces of a plurality of persons along with attribute information corresponding to each person are stored in a face image database. Thereafter, an image database that is different from the face image database can be constructed by performing, for each respective one of a plurality of input images, a processing to extract attribute information corresponding to an image that is stored in the face image database and that matches a respective one of the input images.

In the above-described conventional technologies, subject recognition is performed by comparing the image input as an object to be recognized (hereinafter, referred to as “input image”) with the images previously stored for recognition (hereinafter, referred to as “reference image”). However, in the conventional technologies, the reference image is renewed manually. Particularly, in image recognition apparatuses that recognize persons' faces, since characteristics of faces largely vary with time, a further device is necessary for increasing the success rate in recognition.

### SUMMARY OF THE INVENTION

The present invention is made in view of the above-mentioned related art, and an object thereof is to provide an image recognition apparatus, an image recognition method and a recording medium, each capable of increasing the success rate in recognition, particularly when a subject of a photographic image is recognized.

To attain the above-mentioned object, an image recognition apparatus according to one aspect of one embodiment of the present invention can store one or more reference images used for image recognition, can compare an input image to be recognized with the one or more stored reference images, and can determine whether or not a reference image is similar to the input image. When a reference image that is determined to be similar to an input image is present, the image recognition apparatus can add information on a time of photo taking of the input image to the input image data and can compare information on a time of photo taking of the input image with information on a time of photo taking of the reference image similar to the input image When a result of the comparison is that the input image is newer than the reference image, the stored reference image can be renewed based on the input image.

According to this structure, when an image whose time of photo taking is later than the time of photo taking of a corresponding reference image is input as the input image, the reference image corresponding to that input image can be renewed based on the input image, so that image recognition using more accurate reference images can more easily be performed. Consequently, reduction in the success rate in recognition can be decreased.

Further, by storing reference images, for example, compared to a case where only features of a subject are stored, an advantage is that a comparison can be made with an arbitrary feature of the input image. That is, when only features are stored, a comparison can be made only with a fixed feature. However, there are cases where, for example, the input image and the reference image are different in photo taking conditions, such as the brightness, the size and the direction, and it is preferable that not only features be compared, but also, that a comparison be made after the conditions, such as the brightness, the direction and the size, of the images are made comparable by image processing.

However, in one aspect of one embodiment of the invention, features of a subject can be stored. That is, the “reference image” in this description is a concept including a case where only features are stored and a case where both reference images and features are stored.

In this structure, the image recognition apparatus further can accept input of information on the time of photo taking of the input image and can add this information to the input image. This is because there are cases where the information on the time of photo taking of the input image is not always added to the input image when images are recorded by a digital camera, or the like, and also when image data is obtained from an image scanner, or the like.

Moreover, an image recognition apparatus according to an aspect of one embodiment of the present invention can store at least one reference image used for image recognition, can obtain a real time input image to be recognized, can compare the obtained input image with a reference image stored in reference image memory, can determine whether or not the reference image is similar to the input image, and can renew the reference image based on the input image when the reference image is determined to be similar to the input image.

According to this structure, since the input image is obtained in real time, the input image is always newer than the reference image, so that it is unnecessary to compare the information on the times of photo taking. An example of “obtaining in real time” includes obtaining images from a video camera placed in a fixed position. Here, as the initially obtained image, still image data can intermittently be obtained, or still image data can be extracted from moving image data.

The image recognition apparatus, for example, can extract an image of a person's face from an image, can store the extracted image of the face, can compare the image of the face extracted from the input image with the stored images of faces, and can determine whether or not any of the stored images of faces are similar to the input image.

Further, when images of a plurality of persons' faces are extracted from the input image, the extracted image of each person's face can each be compared successively with the reference images.

Moreover, whether or not an input image and a reference image are similar to each other can be determined by comparing a feature obtained from the input image and a feature obtained from the reference image. Here, as the “feature”, various kinds can be used in addition to the ones shown in the embodiments described later.

An image recognition method according to a further embodiment of the present invention is an image recognition method for recognizing an image by use of reference images, and can include a similarity determination step in which an input image to be recognized is compared with reference images to determine whether or not a reference image is similar to the input image; a photo taking time information comparison step in which when a reference image that is determined to be similar to the input image is present in the similarity determination step, the information on the time of photo taking of the input image is compared with the information on the time of photo taking of the similar reference image; and a renewal step for renewing the reference image based on the input image when a result of the comparison in the photo taking time information comparison step is that the input image is newer than the reference image.

Moreover, a recording medium according to a still further embodiment of the present invention can be a computer-readable recording medium on which a program for instructing a computer to execute the above-described image recognition method is recorded.

These and other objects, advantages and features of the invention will become apparent from the following description thereof taken in conjunction with the accompanying drawings, which illustrate specific embodiments of the invention.

### BRIEF DESCRIPTION OF THE DRAWINGS

In the following description, like parts are designated by like reference numbers throughout the several drawings.

FIG. 1 illustrates a home system according to the structure of a first embodiment of the present invention;

FIG. 2 is a functional block diagram schematically showing the structure of a part of the home system shown in FIG. 1 and an image data storage center 200;

FIG. 3 is a functional block diagram showing the structure of a home server 10 in detail;

FIG. 4 is a view showing an example of the contents of an age-specific number table;

FIG. 5 is a view showing an example of the contents of the information stored in a reference image memory 104;

FIG. 6 is a flowchart of a processing performed by a controller 101 when an image recognition processing is performed in the first embodiment;

FIG. 7 is a flowchart of the processing performed by the controller 101 when the image recognition processing is performed in the first embodiment;

FIG. 8 is a flowchart of the processing performed by the controller 101 when the image recognition processing is performed in the first embodiment;

FIGS. 9(a) and 9(b) are examples of the format of the input images stored in a hard disk drive 102;

FIG. 10 is a flowchart showing the contents of a processing performed by the controller 101 when an age-specific number table update and display processing is performed in the first embodiment;

FIG. 11 is a view showing the structure in a case where an image recognition apparatus of a second embodiment is applied to a surveillance system; and

FIG. 12 is a flowchart showing a processing performed by a server 320 of the second embodiment.

### DETAILED DESCRIPTION OF THE PREFERRED EMBODIMENTS

Embodiments of the present invention will be described with reference to the drawings.

### First Embodiment

(1) General Structure of the Home System

The present embodiment is for managing photographic image data in a home system. FIG. 1 shows the structure of the home system.

As shown in FIG. 1, the home system comprises the following connected together via a home network: a home server 10; an external communication device 20; a video camera 30; a television 40; a telephone 50; a facsimile 60; a printer 70; a personal computer (PC) 80; and a CD-ROM apparatus 90. Although not shown in FIG. 1, apparatuses such as a refrigerator, indoor lighting, an audio apparatus and a breaker can be connected to the home system of the present embodiment. By doing this, electrical appliances and communications in the home can collectively be controlled.

Home server 10 can be connected to a mobile telephone 25 by radio through the external communication apparatus 20 and can perform communications with the outside of the home. Further, as mentioned later, apparatuses such as an image scanner and a digital camera can be connected to PC 80, and the image data generated by these apparatuses can be stored in a hard disk drive (HDD) provided in home server 10.

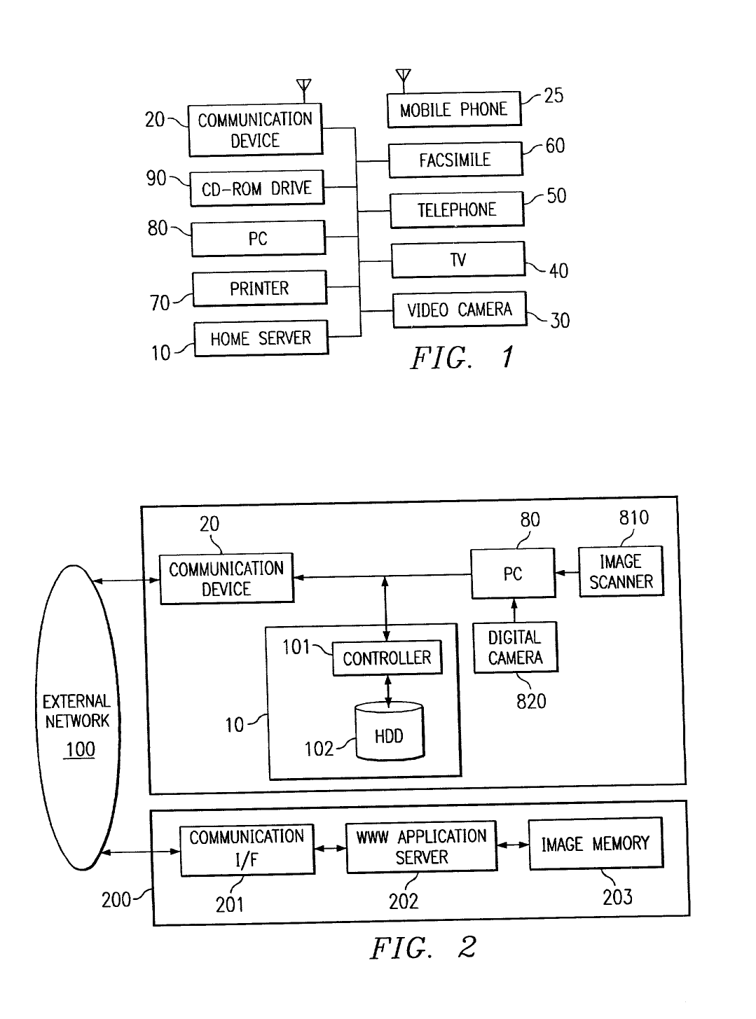

FIG. 2 is a functional block diagram schematically showing the structure of a part of the home system and an image data storage center 200 provided outside the home and connected to the home system through an external network such as the Internet. In FIG. 2, home server 10, PC 80, external communication device 20 and the like are shown as the part of the home system.

In this home system, the image data obtained by reading an original by an image scanner 810 and the image data obtained by photo taking by a digital camera 820 can be stored in an HDD 102 through a controller 101 of home server 10 and can be stored in an image memory 203 of the image data storage center 200 through an external network 100 such as the Internet.

(2) Structure of Home Server 10

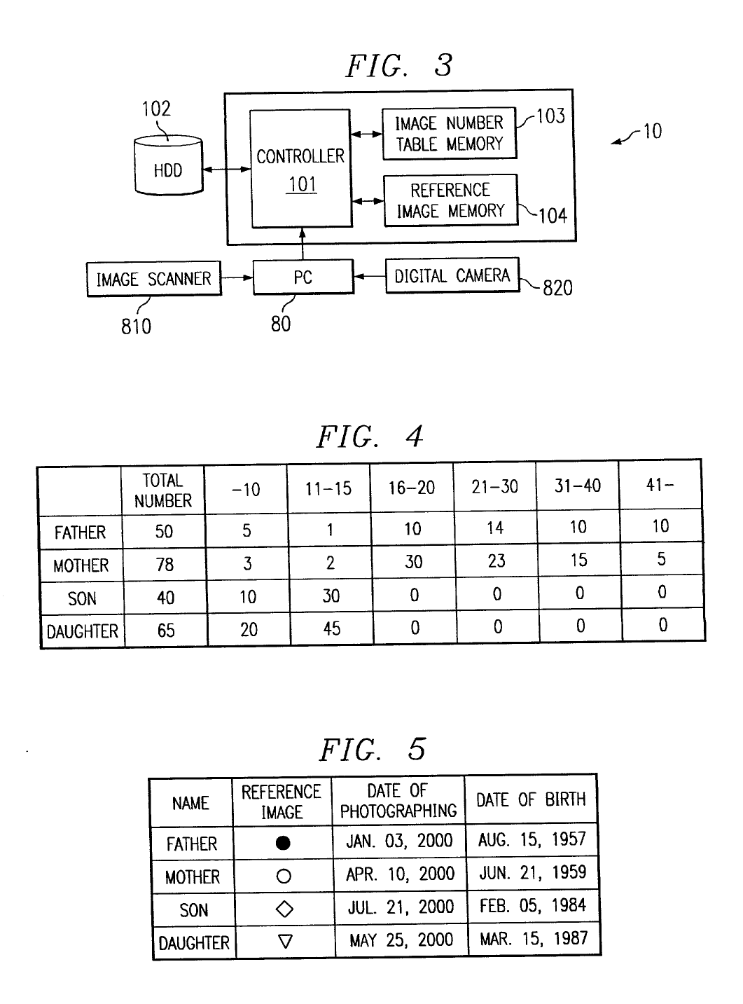

Next, the structure of home server 10 will be described in further detail. FIG. 3 is a functional block diagram showing the structure of the home server 10 in detail. Home server 10 includes an age-specific number table memory 103 and a reference image memory 104 as well as controller 101 and HDD 102, shown in FIG. 2. While age-specific number table memory 103 and reference image memory 104 are shown as separate blocks from HDD 102 in FIG. 3, it is to be noted that, physically, they can be provided in HDD 102.

In age-specific number table memory 103, a table is stored in which the number of image data stored in HDD 102 is stored, for each of the subjects included in the image data, or for each age range (hereinafter, this table will be referred to as “age-specific number table”). FIG. 4 is a view showing an example of the contents of the age-specific number table. In the present embodiment, for each member of a family, the number of image data including the member as a subject is stored for each predetermined age range. The setting of the age ranges can be variable, and even when it is fixed, it can be arbitrary. While the number of images is managed for each member of the family in the example of FIG. 4, the number of images can be managed for a subject other than the members of the family when a reference image of the subject is stored in reference image memory 104.

In the present embodiment, in addition to the recognition of the subject of the input image by comparing the input image and the reference image, the time of photo taking of the input image and the time of photo taking of the reference image are compared, and when the input image is newer, the reference image is renewed based on the input image. Moreover, the age of the subject when an image of the subject was recorded is calculated based on the time of photo taking of the input image and the date of birth of the recognized subject, and the calculated age is added to the input image data when the input image is stored. The age-specific number table can be generated based on the added age. The calculation of the age of the subject in the present embodiment will be described in detail.

In the present embodiment, a reference image of each subject (in the present embodiment, a reference image of each member of a family) for recognizing the subject of the input image, and the date of birth of each subject are stored. The subject included in an input image is recognized by comparing the reference images and the input image, and the age of the subject when the image of the subject was recorded is calculated by comparing the date of photo taking of the input image and the date of birth of the recognized subject. More specifically, the subject is recognized and the age of the subject is calculated based on information stored in the reference image memory 104.

FIG. 5 is a view showing an example of the contents of the information stored in reference image memory 104. As shown in FIG. 5, a reference image of each member of a family, the date of photo taking of each reference image and the date of birth of each member are stored in reference image memory 104. While the reference images are schematically shown as symbols in the figure, in actuality images of faces extracted from input images by an extraction process, which will be described later, are stored as the reference images. As will also be described later, when an image newer than a reference image is inputted, the reference image is renewed based on an image of a face extracted from the input image.

In the present embodiment, new images are always stored as the reference images; however, when photographic image data, like that in the present invention, is managed, since not only a photo that is recently taken by a digital camera or the like, but also image data obtained by reading an old photo by image scanner 810, or the like, are sometimes input as the input image, a plurality of reference images can be stored, for example, by using the newest images for each predetermined age range as the reference images.

While the date of photo taking of the input image is normally automatically added to the input image when the input image is taken by a digital camera or the like, when a photo is read by image scanner 810 or the like, as mentioned above, the date of photo taking can be input by use of an input device such as a keyboard. In a case where the date is imprinted on the photo, the date included in the photo can be read.

(3) Contents of the Processing Performed by Controller 101

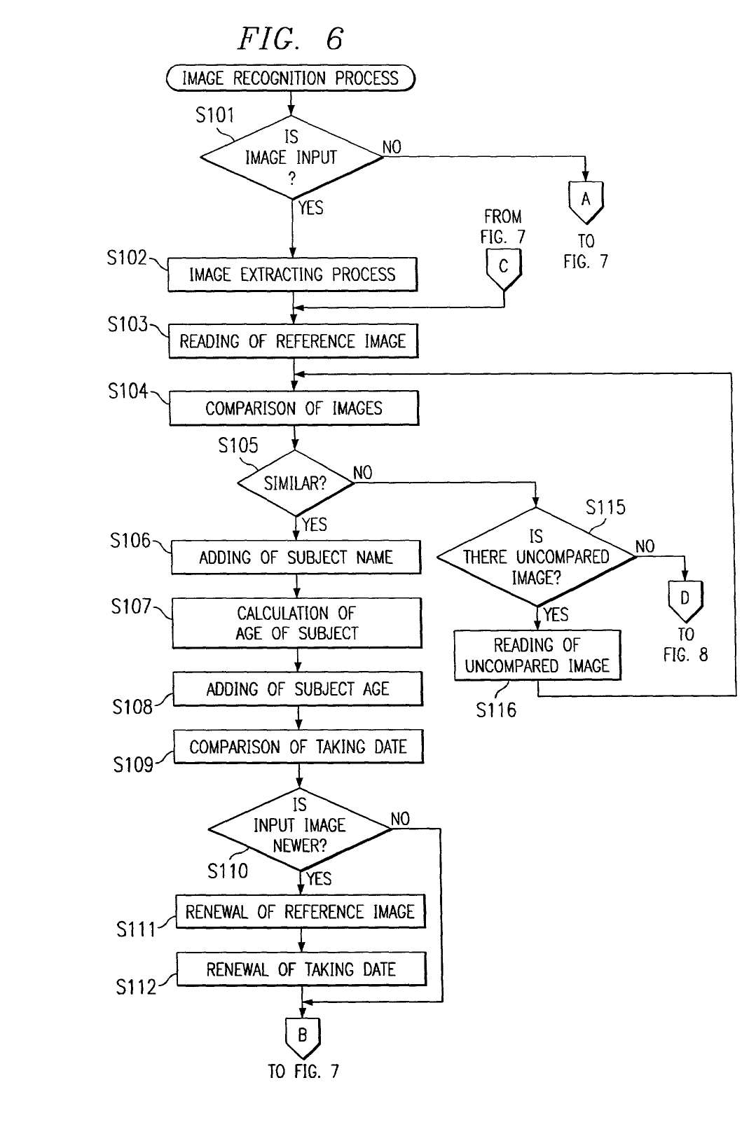

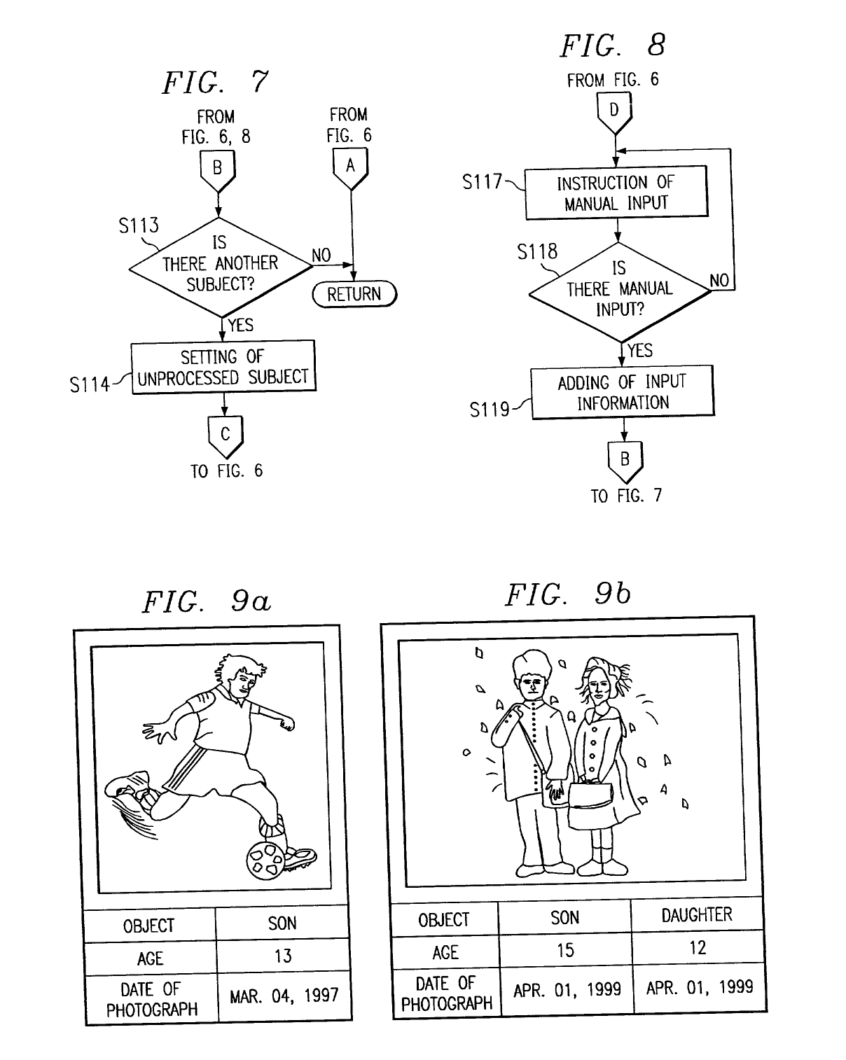

Next, the contents of the processing performed by controller 101 will be described. FIGS. 6 to 8 are flowcharts which will aid in explaining the contents of the processing performed by controller 101 when an image recognition processing is performed.

When an image is input (Yes at S101), first, controller 101 performs the image extraction processing (S102) to obtain an image of the face of the subject from the input image. In this case, when a plurality of subjects are present, an image of the face of each subject can be obtained. As an example of the extraction processing, a method described in U.S. Pat. No. 6,035,074 is applicable.

Then, one reference image is read from reference image memory 104 (S103), and the extracted subject image is compared with the reference image (S104) by means of any known process. For example, a method described in Japanese Laid-open Patent Application No. H05-225344 is applicable to this comparison. When it is determined that the extracted subject image and the reference image are similar to each other (Yes at S105), the name stored in the reference image memory 104 corresponding to the reference image is added to the input image as the name of the subject (S106). The age of the subject when the image of the subject was recorded is then calculated (S107). Thereafter, the age of the subject is added to the input image (S108). The method of calculating the age of the subject when the image of the subject was recorded is not described here because it has been described above.

Now, the addition of the name and the age of the subject to the input image will be described with reference to FIGS. 9(a) and 9(b). FIGS. 9(a) and 9(b) are illustrations which will aid in explaining the format of the photographic images stored in HDD 102. As shown in FIGS. 9(a) and 9(b) in the present embodiment, the names and the ages of the subjects and the dates of photo taking are added to the input images stored in HDD 102. When a plurality of subjects are present, like in the example of FIG. 9(b), the names and other attributes are added for each of the subjects.

Referring back to FIG. 6, after the addition of the name and the age to the input image is finished, information associated with the input image and the reference image is compared, for example, the dates of photo taking of the input image and the reference image are compared with each other (S109). When the input image is newer (Yes at S110), the reference image is renewed based on the input image (S111), and the date of photo taking stored in reference image memory 104 is updated (S112). Consequently, the image of the face extracted from the input image at step S102 is stored in reference image memory 104.

After the above-described processing is finished, the process shifts to the flowchart of FIG. 7, and whether or not another subject is extracted from the input image, is determined (S113). When there is no other subject (No at S113), that is, when recognition of all the subjects is finished, the image recognition processing is finished, and the process returns to a non-illustrated main routine.

When there is another subject that has not been recognized yet (Yes at S113), the unprocessed subject is set as the object of the comparison at step S114, and the process returns to step S103. At step S103 and succeeding steps, reference images are successively read out and image recognition is further performed.

In a case where it is determined at step S105 that the images being compared are not similar to each other (No at S105), when there is a reference image that has not been compared yet (Yes at step S115), the reference image is read out (S116), and the process returns to step S104 to perform the image comparison. When there is no reference image that has not been compared yet (No at S115), that is, when the input image is similar to none of the reference images stored in reference image memory 104, since, although a subject is extracted, the subject cannot be recognized, it is necessary to manually input the information to be added to the input image as required.

In the case that the input image is not similar to a reference image, according to the present embodiment, the process shifts to the flowchart of FIG. 8 to prompt the user to manually input the name and the age of the subject (S117). Then, the process waits until the manual input is made (Yes at S118). When there is a manual input, the input information is added to the input image (S119), and the process then proceeds to step S113 of the flowchart of FIG. 7.

In the present embodiment, while the name, and the like, of a subject may not be reflected in the contents of reference image memory 104, for example, when the name and the date of birth of a new subject are manually inputted at step S118 in FIG. 8, the image of the subject can be added to reference image memory 104. Moreover, when the input name of the subject is the same as a name stored in reference image memory 104, the contents of reference image memory 104 can be updated according to the result of a comparison of the dates of photo taking.

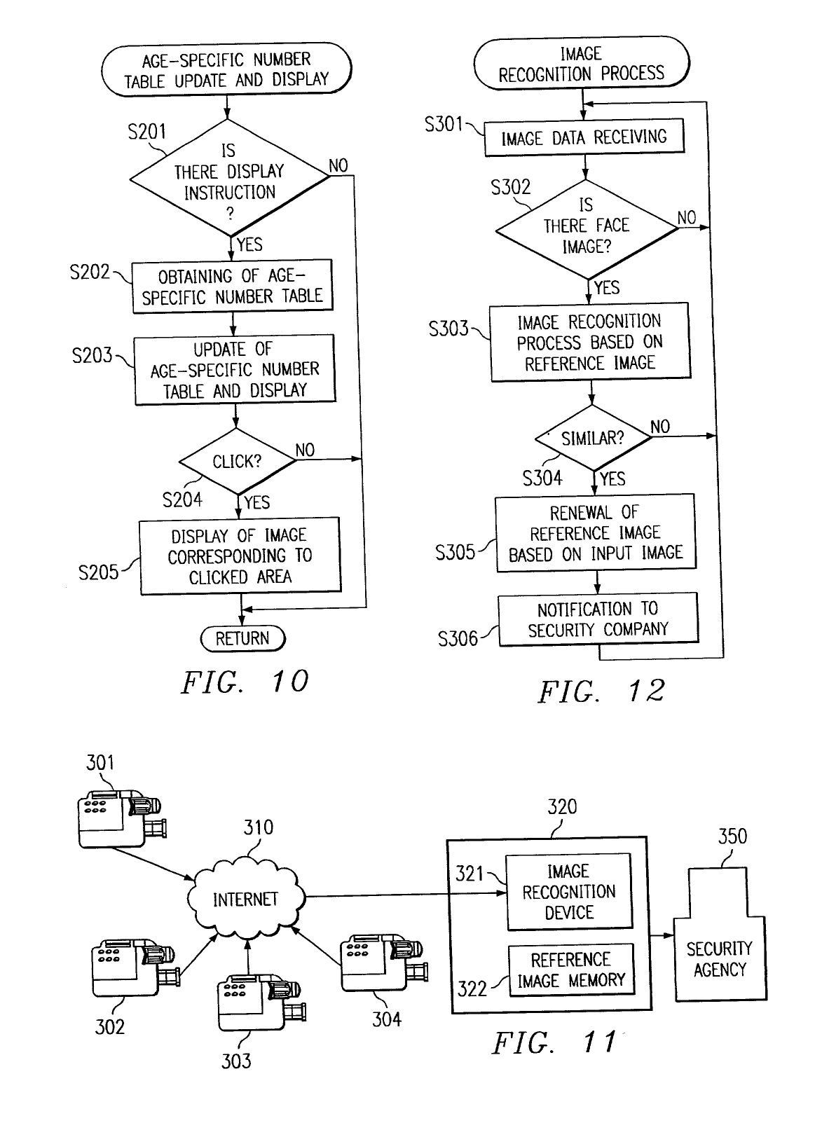

Next, an age-specific number table update and display processing will be described. FIG. 10 is a flowchart showing the contents of the processing performed by controller 101 when the update and display processing is performed. In the present embodiment, in displaying the contents of the age-specific number table, the contents of the age-specific number table are updated and displayed in response to an instruction from the user. However, it is to be noted that the contents of the age-specific number table can be updated when an image is inputted.

The controller 101 determines whether or not there is an instruction from the user to display the contents of the age-specific number table (S201). When there is a display instruction (Yes at S201), age-specific number information, that is, information corresponding to the contents of the age-specific number table is obtained (S202). Specifically, the number of images is counted for each of the subject names added to the images stored in HDD 102 and for each predetermined age group. Then, the contents of the age-specific number table are updated and the table is displayed on a non-illustrated display device (S203). For example, the display device of the PC 80 can be used as a display. In this case, controller 101 transmits the information to be displayed to PC 80 and causes the display device to display, for example, a table as shown in FIG. 4. According to the present embodiment, when a plurality of subjects are present in one image like FIG. 9(b), the subjects are each counted as one image. Other variations are possible, however.

Then, it is determined whether or not the user has clicked on the displayed age-specific number table by use of an input device such as a mouse (S204). This click is performed by specifying a cell of, for example, the table shown in FIG. 5. Detecting this, the controller 101 causes the display device to display a thumbnail image of the image data corresponding to the clicked cell (S205).

The thumbnail image can be generated from the image stored in HDD 102 when the cell is clicked, or can be generated when the image is inputted. Moreover, in addition to the display of the thumbnail image, the thumbnail image can be enlarged (the stored image is displayed) when further clicked.

### Second Embodiment

Next, a second embodiment of the present invention will be described.

While in the first embodiment, the date of photo taking of the input image is compared with the date of photo taking of the reference image and the reference image is renewed when the reference image is newer, in the second embodiment, the input image is obtained in real time. “Obtaining the input image in real time” refers to a case where the input image is obtained from a video camera or the like as occasion arises. In such a case, since the input image is newer than the reference image, it is unnecessary to compare the dates of photo taking of these images. Therefore, when a subject similar to a reference image is present in the input image, the reference image is renewed without the dates of photo taking being compared with each other.

FIG. 11 is a view showing the structure of a surveillance system of the present embodiment. As shown in this figure, this surveillance system comprises four surveillance cameras 301 to 304 connected to a server 320 through the Internet 310. Server 320, including an image recognizer 321 and a reference image memory 322, performs image recognition based on the reference images and the video data transmitted from the surveillance cameras. When a person whose reference image is stored in reference image memory 322 is recognized, a notification is given to a security company 350 or a security section.

FIG. 12 is a flowchart showing the processing performed by the server of the present embodiment. The server 320 receives video data from the surveillance cameras (S301). After extracting still images from the received video data, the server 320 performs the above-described extraction processing, and determines whether or not an image of a person's face is included in the images extracted from the video data (S302).

When an image of a person's face is included (Yes at S302), image recognition is performed based on the reference images stored in the reference image memory 322 (S303). When a similar reference image is present (Yes at S304), the reference image is renewed based on the input image (S305), and a notification is given to the security company 350 (S306).

In the present embodiment, since the input image is always newer than the reference image, it is unnecessary to add the date of photo taking to the reference image and compare the dates. When no face image is included in the received video data (No at S302) and when no similar reference image is present (No at S304), the process returns to step S301 to continue reception from the surveillance cameras.

By performing the above-described processing, for example, it can be detected that a wanted person came to the place where the surveillance cameras are set. Moreover, since the reference image is renewed, erroneous recognition can be prevented.

### Modifications

While embodiments of the present invention have been described, it is to be noted that the present invention is not limited to the examples shown in the embodiments and the following modifications, for example, can be considered:

(1) While in the first embodiment, images extracted from input images are stored as reference images in reference image memory 104, features extracted from the images can be stored.

(2) While in the second embodiment, image recognition and reference image renewal are both performed by server 320, image recognition can be performed by the surveillance cameras. In this case, only reference image renewal is performed by server 320. Moreover, both image recognition and reference image renewal can be performed by the surveillance cameras. In this case, when a reference image is renewed, the renewed reference image is transmitted to the other surveillance cameras.

(3) While in the described embodiments the image recognition apparatus is preinstalled in the home system or the like, the present invention can be realized also by distributing a program performing the above-described image recognition processing. For example, a program performing the image recognition processing of the present invention can be distributed through various kinds of storage media such as a CD-ROM, a DVD-ROM and a floppy disk, or through cable and wireless networks and the like, and the program can be executed in information processors such as a PC and a server to which the program has been distributed. Examples of modes of distributing the program include storing all the software necessary for executing the image recognition method according to the present invention in the above-mentioned various kinds of storage media, and using functions of general purpose programs such as various kinds of operating systems preinstalled in computers.

(4) While the present description describes that an input image can be compared successively with a plurality of references, the invention described herein is equally applicable for comparing an input image with a plurality of reference images simultaneously. Accordingly, of the multiple comparisons that are performed, a reference image that is similar to the input image can be detected. Thereafter, processing for renewal of the reference image or the addition of the input image and information corresponding to the input image to the storage device can be performed as previously described.

According to the above-described image recognition apparatus, since reference images used for image recognition are renewed based on new input images, image recognition using more accurate reference images can be performed more easily so that the amount of reduction in the success rate in recognition can be decrease, even when an image that largely varies with time such as an image of a person's face is recognized. Furthermore, because an input image and information relating to the input image can be stored in the memory of the image recognition apparatus when the input image does not match a reference image in the memory, the recognition capacity of image recognition apparatus can be increased.

Although the present invention has been fully described by way of examples with reference to the accompanying drawings, those skilled in the art will appreciate that various changes and modifications can be made without departing from the scope of the invention as defined in the appended claims.

What is claimed is:

1. An image recognition apparatus comprising:
a reference image memory for storing one or more reference images used for image recognition;
a similarity detector for comparing an input image, to be recognized, with the one or more reference images stored in the reference image memory, and for determining whether or not a reference image is similar to the input image;
a comparison controller that, when the similarity detector determines that a similar reference image that is similar to the input image is present, compares information on a time of photo taking of the input image and a time of photo taking of the similar reference image; and
a renewal controller for renewing the similar reference image stored in the reference image memory based on the input image, when the comparison controller determines that the input image is newer than the similar reference image.

2. An image recognition apparatus according to claim 1, further comprising a photo taking time information receiver that receives input of the information on the time of photo taking of the input image and adds the information to the input image.

3. An image recognition apparatus according to claim 1, further comprising an extractor for extracting an image of a face of a person from an image, said extractor storing the image of the face in the reference image memory, and wherein the similarity detector is adapted to compare the image of the face extracted from the input image by the extractor with images of faces stored in the reference image memory, and to determine whether or not images being compared are similar to each other.

4. An image recognition apparatus according to claim 1, wherein the similarity detector is adapted to compare the input image successively with each of a plurality of reference images stored in the reference image memory.

5. An image recognition apparatus according to claim 1, wherein said similarity detector is adapted to compare a feature obtained from the input image with a feature obtained from a reference image and to determine whether or not the input image and the reference image are similar to each other.

6. An image recognition apparatus comprising:
a reference image memory for storing at least one reference image used for image recognition;
an input image receiver for receiving, in real time, an input image to be recognized;
a similarity detector for comparing the input image received by the input image receiver with the at least one reference image stored in the reference image memory, and for determining whether or not a reference image is similar to the input image; and
a renewal controller for renewing a similar reference image that is similar to the input image based on the input image when the similarity detector determines that the similar reference image is present in the reference image memory.

7. An image recognition apparatus according to claim 6, wherein the similarity detector is adapted to compare the input image successively with reference images stored in the reference image memory.

8. An image recognition apparatus according to claim 6, further comprising:
an extractor for extracting an image of a face of a person from an image, said extractor storing said image of the face in the reference image memory, and
wherein the similarity detector is adapted to compare an image of a face extracted from the input image by the extractor with images of faces stored in the reference image memory, and to determine whether or not images being compared are similar to each other.

9. An image recognition apparatus according to claim 8, wherein, when images of a plurality of faces are extracted from the input image by the extractor, said similarity detector compares the extracted image of each one of said plurality of faces successively with the reference images stored in the reference image memory.

10. An image recognition apparatus according to claim 6, wherein said similarity detector compares a feature obtained from the input image with a feature obtained from a reference image and to determine whether or not the input image and the reference image are similar to each other.

11. A method for recognizing an image by use of a plurality of reference images, comprising the steps of:
comparing an input image to be recognized with the reference images and determining whether or not the input image is similar to one of said plurality of reference images;
comparing, when a similar reference image is determined to be similar to the input image, a time of photo taking of the input image with a time of photo taking of the similar reference image; and
renewing the similar reference image, based on the input image, when a result of the comparison of the time of photo taking of the input image and the time of photo taking of the similar reference image is that the input image is newer than the similar reference image.

12. An image recognition method according to claim 11, wherein the input image is compared successively with reference images.

13. A computer-readable recording medium having recorded thereon a program for performing a method comprising the steps of:
comparing an input image to be recognized with at least one reference image and determining whether or not the input image is similar to said at least one reference image;
comparing, when a similar reference image is determined to be similar to the input image, a time of photo taking of the input image with a time of photo taking of the similar reference image; and
renewing the similar reference image, based on the input image, when a result of the comparison of the time of photo taking of the input image and the time of photo taking of the similar reference image is that the input image is newer than the similar reference image.

14. An image recognition apparatus comprising:
a reference image memory for storing at least one reference image;
a similarity detector for comparing an input image with a reference image from said reference image memory and for determining whether or not said reference image is similar to said input image;
a time comparison controller for comparing a time associated with said input image and a time associated with said reference image, when said similarity detector determines that said reference image is similar to said input image; and
a renewal controller, responsive to a result of the comparison performed by said time comparison controller, for determining whether or not said reference image should be renewed based on said input image.

15. An image recognition apparatus according to claim 14 wherein,
said renewal controller is adapted to renew said reference image based on said input image when said time associated with said input image is after said time associated with said reference image.

16. An image recognition apparatus according to claim 14 wherein,
said similarity detector is adapted to compare a different reference image with said input image, when said similarity detector determines that said input image is not similar to said reference image.

17. An image recognition apparatus according to claim 14, wherein
when said similarity detector determines that said reference image is not similar to said input image, said reference image memory is adapted to store said input image and information relating to said input image.

18. An image recognition apparatus according to claim 17, wherein when said information relating to said input image matches information relating to said reference image, said renewal controller is adapted to renew said reference image based on said input image when said time comparison controller determines that said time associated with said input image is after a time associated with said reference image.

19. A method for recognizing an image comprising the steps of:
comparing an input image with at least one reference image and detecting whether or not the input image is similar to the at least one reference image;
comparing, when a similar reference image is determined to be similar to the input image, a time associated with the input image with a time associated with the similar reference image; and
renewing the similar reference image based on the input image depending on a result of the comparison of the time associated with the input image and the time associated with the similar reference image.

20. A method for recognizing an image according to claim 19, wherein said step of renewing the similar reference image is performed when the time associated with the input image is after the time associated with the similar reference image.
